(19) United States
(12) Patent Application Publication
(10) Pub. No.: US 2024/0331960 A1
(43) Pub. Date: Oct. 3, 2024

(54) PRODUCTION PROCESS FOR A CONTACT ELEMENT FOR VACUUM SWITCHES, CONTACT ELEMENT AND VACUUM SWITCH

(71) Applicant: Siemens Aktiengesellschaft, Munchen (DE)

(72) Inventors: Frank Graskowski, Wandlitz (DE); Carsten Schuh, Baldham (DE); Eckehard Isenberg, Brieselang (DE); Hermann Bödinger, München (DE); Kira Berdien Wüstenberg, Berlin (DE); Alexander Ziefle, Potsdam (DE)

(21) Appl. No.: 18/693,024

(22) PCT Filed: Sep. 15, 2022
(86) PCT No.: PCT/EP2022/075611

§ 371 Date: Mar. 18, 2024

(30) Foreign Application Priority Data
Sep. 23, 2021 (DE) 10 2021 210 641.2

(51) Int. Cl. H01H 33/664; H01H 11/04

(52) U.S. Cl. CPC H01H 33/6646; H01H 11/048

(57) ABSTRACT

A process for producing a contact element for a vacuum switch is provided. In this process, a first powder-like mixture, including particles of a first and second conductive material, or a first pre-pressed, disc-shaped green body, is introduced into a pressing die. An inner pressing stamp is introduced into the die and a second powder of the first conductive material or a second powder-like mixture including, particles of the first conductive material or a second pre-pressed green body including the first conductive material, is introduced into an intermediate space. An outer pressing stamp is introduced into the intermediate space between the die and the inner pressing stamp. Pressing pressure is exerted on the outer and inner pressing stamps, forming a contact disc of the contact element, and a region forming a contact body or contact carrier of the contact element is created.

### CROSS-REFERENCE TO RELATED APPLICATIONS

This application claims priority to PCT Application No. PCT/EP2022/075611, having a filing date of Sep. 15, 2022, which claims priority to German Application 10 2021 210 641.2, having a filing date of Sep. 23, 2021, the entire contents both of which are hereby incorporated by reference.

### FIELD OF TECHNOLOGY

The following relates to a novel method for producing a contact element for vacuum switches, to a contact element produced or producible in accordance with the method, and to a vacuum switch having such a contact element.

### BACKGROUND

In vacuum switches, or vacuum interrupters, for the low-, medium- and high-voltage range, what are referred to as radial or axial magnetic field contacts (RMF and AMF contacts, respectively) are used in particular for turning off currents greater than a few kiloamperes. The structure, function and operating principles of such contact elements with a conventional design are described comprehensively, for example in the dissertation published in 2003: “Modellierung des Plasmas im Vakuum-Leistungsschalter unter Berücksichtigung axialer Magnetfelder” [Modeling the plasma in a vacuum circuit breaker with consideration of axial magnetic fields], by K. Jenkes-Botterweck, available online at http://publications.rwth-aachen.de/record/58842.

Spiral contact and pot contact are widespread designs. In the case of the spiral contact, disclosed for example in DE102019216869A1 and DE102017214805A1, the required magnetic field is generated by the geometric shape of the contact disk itself; in the case of other contact shapes, in particular in the case of the pot contact, which is likewise known for example from DE102017214805A1, the magnetic field is formed by an additional coil former, on which the contact disk is placed.

The coil formers are manufactured from copper rod material or from pre-shaped copper pellets. A magnetic field is generated by the coil former, which is frequently in the form of a hollow cylinder, by an appropriate provision of slots. Specifically in the case of AMF contacts, the contact disks are also frequently provided with slots in order to reduce eddy currents. The slots in both parts have to be aligned with one another during installation.

The contact disk and contact carrier of conventional contact elements are therefore manufactured in different working steps and from different materials in order to achieve the respectively desired properties. In the case of the contact carrier, this is in particular high conductivity; in the case of the contact disk, an essential property is the resistance to combustion arising due to arc events during switching.

In a subsequent manufacturing step, the contact disk and contact carrier are connected to each other by integral bonding, for example by hard soldering. This manufacturing step is broken down in practice into a plurality of individual steps and causes a considerable outlay and considerable costs since the quality of the connection between the contact disk and contact carrier has a decisive effect on the switching performance of the vacuum interrupters. In addition, the assessment required for this reason or quality control of the connection between the contact disk and contact carrier are possible only with a considerable outlay.

DE 33 02 595 A1 discloses a contact carrier, in which an element which is helically wound, or is provided with helical recesses, made from a first material of lower electrical conductivity is potted with a second material of higher conductivity and a lower melting point and pouring temperature, wherein in particular the spaces between the helical windings or the recesses are potted. Here, the element manufactured from the first material is a part of the casting mold for the second material. A contact disk is then soldered onto the contact-making end face of the contact carrier, as already explained above.

DE 195 13 790 A1 discloses a contact element, in which an arc electrode part, an arc electrode holding part, a coil electrode part and an electrode bar (current supply part) are designed in such a manner that they form an integral structure. At least one of the connecting regions between the arc electrode part and the arc electrode holding part, the coil electrode part and the current supply part is produced integrally in accordance with hot isostatic pressing (HIP). A disadvantage of the method described in DE 195 13 790 A1 is that it requires a plurality of individual steps.

### SUMMARY

An aspect relates to an improved method for producing a contact element, and a contact element, as a result of which the described disadvantages are avoided.

This aspect is achieved according to embodiments of the invention by a production method, in which a first powder-like mixture, comprising particles of the first conductive material and particles of the second conductive material, or a first pre-pressed, disk-shaped green body consisting of a composite of at least the first and the second conductive material, is introduced into a pressing die. An inner pressing stamp is introduced into the die, and a second powder of the first conductive material or a second powder-like mixture, comprising particles of the first conductive material, or a second pre-pressed green body, comprising the first conductive material, is introduced into an intermediate space between the die and inner pressing stamp. An outer pressing stamp is introduced into the intermediate space between the die and inner pressing stamp.

Pressing pressure is exerted on the outer pressing stamp and on the inner pressing stamp, specifically in such a way that a disk-shaped region forming the contact disk of the contact element is created from the first powder-like mixture or the first green body, and a region forming the contact body or contact carrier of the contact element is created from the second powder or the second powder-like mixture or the second green body.

In an advantageous development of the method according to embodiments of the invention, an electrical voltage is additionally applied to the pressing stamps and the die.

In an advantageous development, the voltage feed-in points and the respectively fed-in electrical power are selected in such a way that the currents flowing through the powder or green body are distributed approximately uniformly.

In an advantageous development, the die and/or the pressing stamps are provided with a release agent, in particular a graphite coating or a boron nitride coating, before being brought into contact with one of the powders or green bodies.

In an advantageous development, the first powder is a mixture of copper particles and chromium particles, in particular in the ratio CuCr25 or CuCr30 or CuCr35.

In an advantageous development, after pressing and sintering of the powders and/or green bodies, a plurality of circumferentially distributed, oblique slots are introduced into the contact element or the region forming the contact body in such a way that, during a flow of current, a magnetic field can be generated which brings about a movement of a resulting arc on a predetermined path and/or an extensive spreading of the arc.

Embodiments of the present invention furthermore relate to a contact element for a vacuum switch produced or producible by the aforementioned method, having a contact body consisting of a first conductive material or a composite material which comprises a first conductive material, and a contact disk consisting of a composite material, in particular a particle composite material, which, in addition to the first conductive material, comprises at least one second conductive material.

The contact element is a standard body with at least two regions with a different material composition, wherein the material composition of the two regions is oriented to the above-explained requirements: the material of the region which corresponds to the contact carrier or the contact body of a conventional contact element is selected in such a manner that it has high conductivity, and the material of the region which corresponds to the contact disk of a conventional contact element is selected in such a manner that it is resistant to the combustion resulting due to arc events during switching.

In advantageous developments of embodiments of the present invention, the first conductive material is copper.

In advantageous developments of embodiments of the present invention, the second conductive material is chromium, wherein in particular CuCr25 or CuCr30 or CuCr35 is used as the (particle) composite material.

Embodiments of the present invention furthermore relate to a vacuum switch having a vacuum chamber within which two contact elements are arranged, wherein at least one of the contact elements is designed according to the embodiments of the present invention.

One advantage of embodiments of the present invention consists in that the manufacturing outlay for a contact element according to embodiments of the invention is reduced in comparison to the conventional art. In particular, the soldering of the various parts used in the conventional art for the contact body and the contact disk, and the preparatory steps required in this connection are dispensed with. Furthermore, the effect achieved by the embodiments of the present invention is that the connection between the contact body and contact disk is ideal at every location and does not have blemishes due to air pockets, locally different soldering temperatures or mechanically or thermally induced enlarged soldering gaps or surface impurities, etc., which have a negative effect on the magnetic field and may lead to an increase in the electrical resistance of the vacuum interrupter.

### BRIEF DESCRIPTION

Some of the embodiments will be described in detail, with references to the following figures, wherein like designations denote like members, wherein:

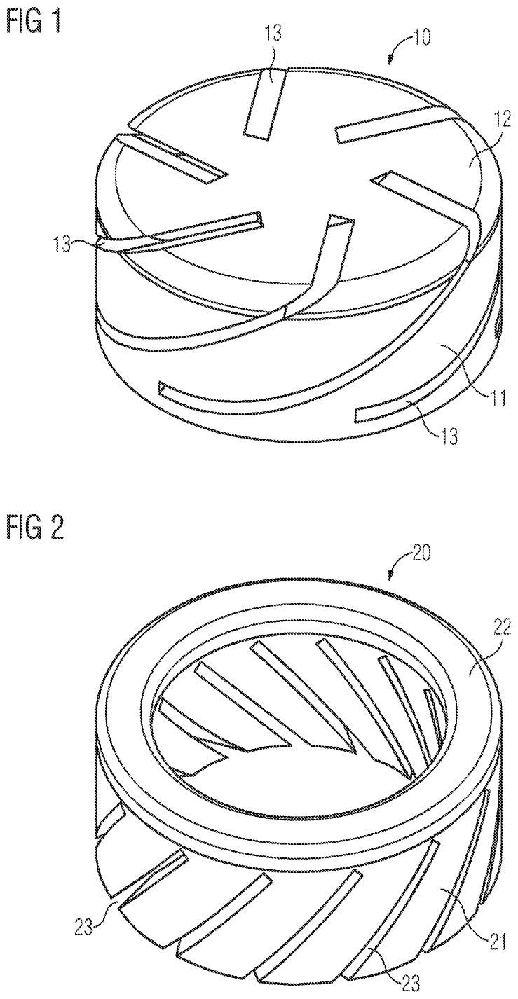

FIG. 1 shows an AMF contact according to one exemplary embodiment of the present invention in a schematic illustration;

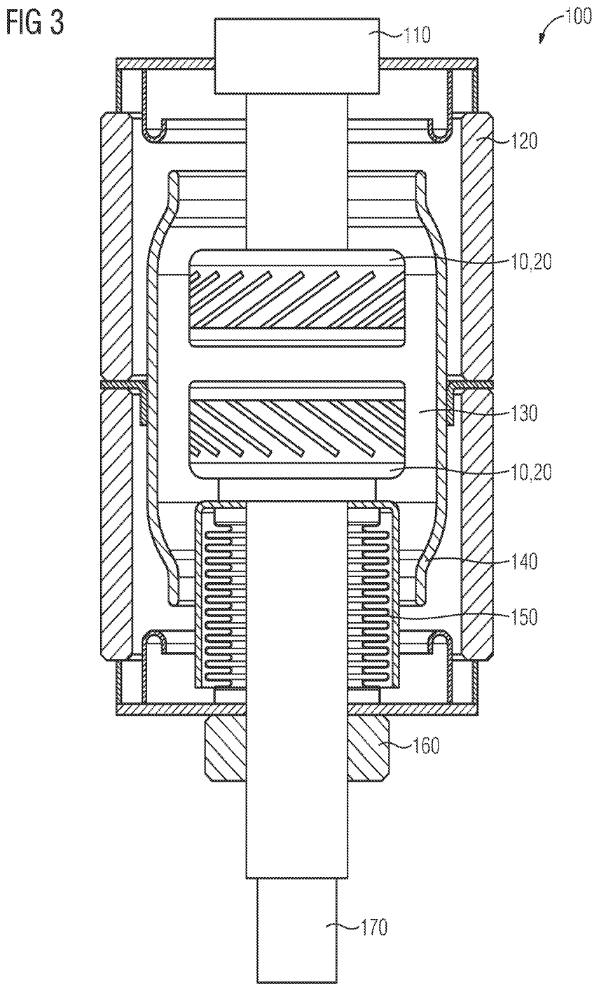

FIG. 2 shows an RMF contact according to a further exemplary embodiment of the present invention in a schematic illustration;

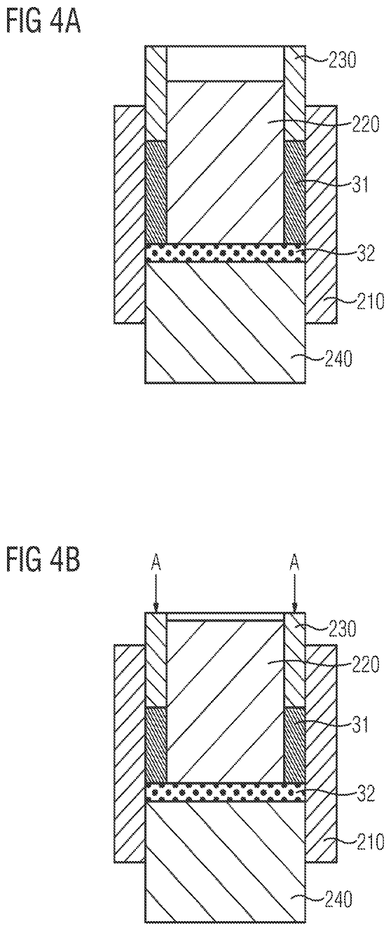

FIG. 3 shows a vacuum switch according to one exemplary embodiment of the present invention schematically in a partial sectional illustration;

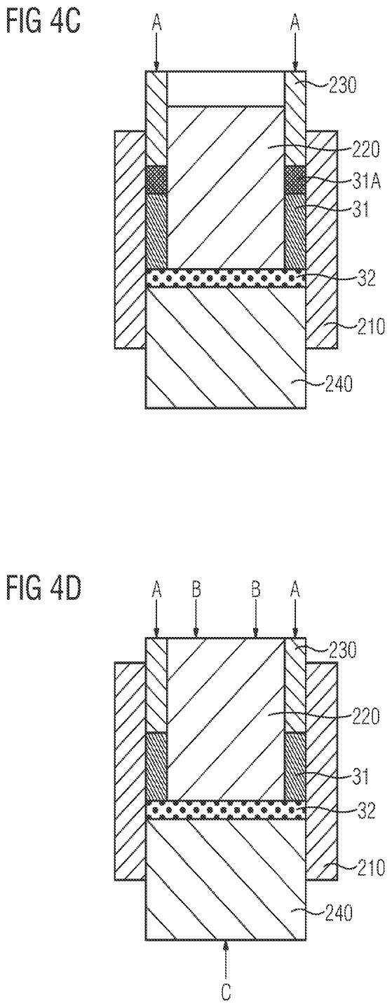

FIG. 4A shows an exemplary embodiment of the production method according to the invention;

FIG. 4B shows an exemplary embodiment of the production method according to the invention;

FIG. 4C shows an exemplary embodiment of the production method according to the invention; and

FIG. 4D shows an exemplary embodiment of the production method according to the invention.

### DETAILED DESCRIPTION

FIG. 1 shows an AMF contact element 10 for a vacuum switch having a contact body 11 consisting of or including a first conductive material or a composite material which comprises a first conductive material.

The first conductive material is copper.

A contact disk 12 or a contact disk region is formed integrally on a surface of the contact body 11, more precisely on the surface of the contact body that is intended later to form the separable electrical connection of the vacuum switch.

The contact disk 12 is composed of a composite material, in particular a particle composite material, which, in addition to the first conductive material, has at least one second conductive material. The second conductive material is chromium or another material which increases the resistance of the composite material to combustion.

The contact element 10 has a plurality of circumferentially distributed, oblique slots 13 which are introduced into the contact element in such a way that they (together with the geometry of the corresponding counter contact) bring about the formation of an axial magnetic field and thus an extensive distribution of the resulting arc on the contact disk.

FIG. 2 shows an RMF contact element 20 for a vacuum switch with a contact body 21 in turn consisting of a first conductive material or a composite material which comprises a first conductive material. The first conductive material here too is copper.

An annular contact disk 22 or an annular contact disk region is in turn formed integrally on a surface of the contact body 21, more precisely on the surface of the contact body that is intended later to form the separable electrical connection of the vacuum switch.

The annular contact disk 22 consists of a composite material, in particular a particle composite material, which, in addition to the first conductive material, comprises at least one second conductive material. The second conductive material here too is chromium or another material which increases the resistance of the composite material to combustion.

The contact body 21 has a plurality of circumferentially distributed, oblique slots 23 which are introduced into the contact body in such a way that they (together with the geometry of the corresponding counter contact) distribute the thermal load of the contacts by rotation of the arc about the longitudinal axis of the arrangement on the contact disks.

FIG. 3 shows a vacuum interrupter 100 with two contacts 10, 20 according to the embodiments of the present invention. In this case, two RMF contacts 20 according to FIG. 2, the various regions 21, 22 of which are shown significantly differently for the purpose of better distinguishability, are illustrated in detail purely by way of example. In other exemplary embodiments, AMF contacts according to FIG. 1 or other contact forms which are conceived in accordance with the embodiments of the present invention are used.

The vacuum switch 100 has a fixed connection disk or a fixed connection pin 110 made of conductive material, for example, of copper. This is connected to a fixed contact 10, 20 according to embodiments of the present invention. A movable contact 10, 20 according to embodiments of the present invention is oriented plane-parallel to the fixed contact and is supported by a movable connection pin 170. An axial movement of the movable connection pin 170 in the direction of the fixed connection pin 110 closes the vacuum switch, and a movement in the opposite direction opens the vacuum switch. The movable connection pin is guided here in a guide 160.

The two contacts 10, 20 are arranged here in a vacuum chamber 130 which is clad with a shield 140 and consists of a body 120 made of insulating material. A metal expansion bellows 150 is used for sealing the vacuum chamber 130 in relation to the environment in the region of the feedthrough of the movable connection pin into the vacuum chamber.

FIG. 4 shows an exemplary embodiment of the production method according to embodiments of the invention by way of the example of an AMF contact according to FIG. 1. The exemplary embodiment uses a field- and pressure-assisted sintering method, what is referred to as the spark-plasma sintering method (SPS method).

According to embodiments of the present invention, a contact element 10, 20 is produced by a starting powder or a pre-pressed green body being introduced into a die and being subjected to a uniaxially acting pressure via pressing stamps. At the same time, electrical current flows in the manner of a series circuit via the pressing stamps and the stamps of the die through the sample to be sintered. The resulting Joule heating of the sample and/or of the die leads to very rapid heating up of the sample and thus permits efficient sintering of the material.

A mixture 32 of particles of a first and a second material, copper and chromium, according to one of the mixtures already mentioned of copper and chromium with a chromium portion of 25% or 30% of 35%, forms the starting point in FIG. 4A. The mixture is placed into the pressing die consisting of a sleeve 210 and a lower stamp 240. Instead of the powder, it is also possible to place a disk-shaped, pre-pressed green body into the die. This flatly distributed material 32 or the disk-shaped green body later forms the contact disk region 12, 22 of the contact element 10, 20.

An inner pressing stamp 220 in the form of a cylinder, which has a smaller outer diameter than the inner diameter of the sleeve 210 of the pressing die, is then introduced.

Powder 31 of the first material, i.e., copper powder, is then poured into the resulting gap or clearance between the inner pressing stamp 220 and the sleeve 210 of the die. Alternatively thereto, a hollow-cylindrical, pre-pressed green body or a pre-processed cylinder blank may also be inserted here. This powder 31 or the hollow-cylindrical green body subsequently forms the contact body region 11, 21 of the contact element 10, 20.

Subsequently, FIG. 4B, an outer pressing stamp 230 in the form of a tubular portion or hollow cylinder is introduced, which fits precisely into the gap or clearance between the inner pressing stamp 220 and the sleeve 210 and exerts a pressing pressure A. In an embodiment, at the same time, a voltage is applied to the pressing tools in order to bring about the targeted heating described further above.

The shape of the outer pressing stamp 230 is selected in such a manner that, when a pressing pressure A is exerted, first of all the powder 31 stratified higher is pressed, before the pressing pressure A is optionally increased and also acts as pressing pressure B on the inner pressing stamp, FIG. 4D, such that the pressing pressure and the electrical current are applied distributed as uniformly as possible over the entire area of the two pressing stamps 220, 230.

In refinements of the embodiments of the invention, the pressing or sintering can take place in two steps in that, following a first pressing step shown in FIG. 4B, the outer pressing stamp 230 is removed, further powder 31A is poured into the gap or clearance between the inner pressing stamp 220 and the sleeve 210, and the outer pressing stamp 230 is introduced again into the gap or clearance between the inner pressing stamp 220 and the sleeve 210, and the second, final pressing is carried out, FIG. 4C and FIG. 4D.

FIG. 4D shows a particular exemplary embodiment with a lower stamp 240 which is movable in relation to the sleeve 210, and a pressing action A on the outer stamp 230, pressing action B on the inner stamp 220, and pressing action C on the lower stamp 240. The pressing action A and B and C is brought about by a press, with the shape of the inner and the outer pressing stamp described in conjunction with FIG. 4B having the effect that first of all a pressing pressure A acts only on the outer pressing stamp 230 and only after a certain compression of the powder 31 is a pressing pressure B also exerted on the inner pressing stamp 220 and the powder 32 compressed, this optionally being assisted by a movement C of the lower stamp 240 in relation to the sleeve 210. By the exertion of the pressing pressure or the pressing pressures and optionally the application of an electrical voltage, sintering takes place with at least diffusion processes and generally also chemical reactions and/or formations of alloys in the interface region between the two materials.

In embodiments, the method described above produces a tight, monolithic contact having a contact disk region 12, 22 and a coil former region 11, 21 in-situ.

Metal surfaces which are in contact with one another and/or the surfaces of the individual parts 210, 220, 230, 240 of the pressing die which are in contact with the powder or green body to be sintered are provided with a release agent, for example with a graphite coating or with a boron nitride coating. Such a release agent makes it possible to disassemble the pressing die and to remove the produced composite body after the pressing operation.

With the method described above, it is possible to produce full surface contact disks 10, as shown in FIG. 1, and annular contact disks 20, as shown in FIG. 2.

At the end of the SPS method, a contact element is available, the surfaces of which still have to be machined, depending on the quality to be achieved, for example by polishing, for example in order to achieve as flat and groove-free a contact surface as possible. Similarly, it is generally required also to provide slots in the coil former or throughout the contact, as discussed in conjunction with FIG. 1 and FIG. 2.

It is of advantage for the slots to be able to be introduced into the contact disk regions 12, 22 and the contact body regions 11, 21 in one working step and for the laborious alignment of pre-slotted individual elements, as is required in the conventional art, to be able to be dispensed with. It is also of advantage that the sintered contact element is very close to the final contour, i.e., only a little waste material occurs during the final machining.

In advantageous developments of embodiments of the present invention, it is possible also to manufacture the contact body from a composite material by, instead of pure copper powder 31, 31A, adding a suitable powder mixture of copper and a further material, the powder mixture when sintered exceeding the strength of copper. This may also take place in a locally restricted way, i.e., for example, in regions of the contact body 11, 21 which are exposed to particular mechanical and/or electrical loads, such as the joining points between contact 10, 20 and connection pin 110, 170.

In exemplary embodiments of the invention, it is possible, in a first sintering operation, first of all to produce an annular contact disk region and, in a second sintering operation, to configure this annular contact disk region into a full surface contact disk (not illustrated). For the annular contact disk region, it is possible to select a different material composition than for the inner contact disk region; for example, the portion of chromium in the inner contact disk region can be increased in relation to the surrounding annular contact disk region, or other materials may be added. A full surface contact disk 12 can thus be produced, the conductivity and magnetic properties of which vary over the radius of the contact disk in order thus to influence the distribution of current and/or dissipation of heat in the contacted state and/or the guidance of the arc during the opening operation.

In other exemplary embodiments of the invention, material compositions varying over the radius of the contact disk can be achieved by radically different powder compositions instead of a uniformly mixed powder 32 being poured into the pressing die. This configuration has the advantage that flowing transitions between the individual regions are formed and therefore the electrical and/or magnetic properties change less abruptly than in the above-described exemplary embodiment.

It should be emphasized that only selected exemplary embodiments that make use of the present invention have been described here. In particular, it is possible, for example, to design and to manufacture other forms of contacts by the principles described here. Similarly, although the materials referred to as being desired are desired, embodiments of the invention are not restricted to these materials. Furthermore, as already mentioned, it is possible, for example, instead of the sintering method, to select an additive production method (3D printing), for which most of the considerations and advantages disclosed in conjunction with the sintering method are applicable.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for producing a contact element for a vacuum switch, comprising:
introducing a first powder-like mixture, comprising particles of a first conductive material and particles of a second conductive material, or a first pre-pressed, disk-shaped green body comprising of a composite of at least a first and a second conductive material, into a pressing die;
introducing an inner pressing stamp into the die;
pouring a second powder of the first conductive material or a second powder-like mixture, including particles of the first conductive material, or a second pre-pressed green body, including the first conductive material, into an intermediate space between the die and inner pressing stamp;
introducing an outer pressing stamp into the intermediate space between the die and inner pressing stamp; and
exerting pressing pressure on the outer pressing stamp and on the inner pressing stamp in such a way that a disk-shaped region forming a contact disk of the contact element is created from the first powder-like mixture or the first green body, and a region forming a contact body of the contact element is created from the second powder or the second powder-like mixture or the second green body.

2. The method as claimed in claim 1, wherein an electrical voltage is additionally applied to the pressing stamps and the die.

3. The method as claimed in claim 2, wherein voltage feed-in points and the respectively fed-in electrical power are selected in such a way that the electrical currents flowing through the powder or green body are distributed approximately uniformly.

4. The method as claimed in claim 1, wherein the die and/or the pressing stamps are provided with a release agent before being brought into contact with one of the powders or green bodies.

5. The method as claimed in claim 1, wherein the first powder is a mixture of copper particles and chromium particles.

6. The method as claimed in claim 1, in which, wherein after pressing and sintering of the powders and/or green bodies, a plurality of circumferentially distributed, oblique slots are introduced into the contact element or the region forming the contact body thereof in such a way that, during a flow of current, a magnetic field is generated which brings about a movement of a resulting arc on a predetermined path and/or an extensive spreading of the arc.

7. A contact element for a vacuum switch; produced or producible by the method claim 1, having a contact body consisting of a first conductive material or a composite material which comprises a first conductive material, and a contact disk consisting of a composite material which, in addition to the first conductive material, comprises at least one second conductive material.

8. The contact element as claimed in claim 7, wherein the first conductive material is copper.

9. The contact element as claimed in claim 7, wherein the second conductive material is chromium.

10. The contact element as claimed in claim 9, wherein the composite material is CuCr25 or CuCr30 or CuCr35.

11. A vacuum switch having a vacuum chamber within which two contact elements are arranged, wherein at least one of the contact elements is a contact element as claimed in claim 7.
